(19) United States
(12) Patent Application Publication
(10) Pub. No.: US 2019/0040805 A1
(43) Pub. Date: Feb. 7, 2019

(54) Pressure-Based Detection of Poor Fire and Misfire

(71) Applicant: Woodward, Inc., Fort Collins, CO (US)

(72) Inventors: Jason Barta, Fort Collins, CO (US); Gregory James Hampson, Boulder, CO (US)

(21) Appl. No.: 15/666,350

(22) Filed: Aug. 1, 2017

(51) Int. Cl. F02D 35/02; F02D 41/26; F02D 41/22; F02D 43/04; F02P 5/153

(52) U.S. Cl. CPC F02D 35/023; F02D 35/028; F02P 5/153; F02D 41/22; F02D 43/04; F02D 41/263

(57) ABSTRACT

An apparatus for monitoring combustion and/or controlling operation of an internal combustion engine includes a processor to receive input from a crank angle sensor and a combustion chamber pressure sensor. The processor receives a first pressure signal during a first volume during the compression phase and a second pressure signal during a second volume corresponding to a portion of expansion phase, where volumes are equal or equivalent. The processor determines an indication of combustion quality of each combustion event, such as poor fire or misfire, based on a comparison of the difference between the first and second pressures to a threshold value associated with each volume.

### BACKGROUND

Internal combustion engines, including gasoline engines and natural gas engines, ignite an air-fuel mixture to produce combustion in one or more engine cylinders. Typical internal combustion engine systems inject fuel and air into a combustion chamber (e.g., the cylinder) of the engine and ignite the fuel-air mixture using an igniter, such as a spark plug or a glow plug. In response to consumer and regulatory demands, typical internal combustion engines push the limits on combustion towards more fuel-efficient operation modes, such as those that use lean combustion to reduce fuel combustion. However, lean combustion increases the risk for inadequate combustion events, such as misfire and poor fire. To compensate for misfire and poor fire, typical engine systems attempt to detect their occurrence by monitoring crank shaft speed between each ignition event and compensate by changing operating parameters, such as air/fuel ratio or igniting timing.

### DESCRIPTION OF DRAWINGS

FIG. 1 is a schematic of a cross-sectional view of a cylinder of an internal combustion engine including an engine control system.

FIG. 2A is a schematic of the engine control system of FIG. 1.

FIG. 2B is a schematic showing inputs and output parameters for the engine control unit of FIG. 2A.

FIG. 2C is a block diagram of internal operations of the engine control unit of FIG. 2A.

FIG. 3 is a graph of a pressure trace of a combustion event in a cylinder plotted with a curve of the isentropic expansion and compression of the cylinder without combustion.

FIG. 4 is a pressure vs. volume graph for the combustion event of FIG. 3.

FIG. 5 is graph of a pressure trace of a combustion event in a cylinder plotted with a curve of the isentropic expansion and compression of the cylinder without combustion.

FIG. 6 is the graph of FIG. 5, including pressure traces of different inadequate combustion events and example detection windows.

FIG. 7 is a flow chart of the misfire and poor fire detection algorithm.

FIG. 8A is a graph of a pressure trace of a poor fire combustion event.

FIG. 8B is a pressure vs. volume graph for the combustion event of FIG. 8A.

FIG. 9A is a graph of a pressure trace of a misfire combustion event.

FIG. 9B is a pressure vs. volume graph for the combustion event of FIG. 9A.

FIG. 10A is a graph of a pressure trace of a combustion event.

FIG. 10B is a pressure vs. volume graph for the combustion event of FIG. 10A.

Like reference symbols in the various drawings indicate like elements.

### DETAILED DESCRIPTION

Lean fuel-air mixtures are used in many of today's internal combustion engines to reduce nitrous oxides (NOx) emissions, and recent reductions in emission regulations are pushing NOx limits to the lower limits of 1, ½, ¼ and ⅛ TA Luft,(where 1 TA Luft=1.0 gm/kw-hr of NOx emissions). However, as fuel-air mixtures becomes leaner, the flame temperature and flame speed of combustion also get lower, and this increases the risk of poor fire (i.e., late combustion) and misfire (i.e., no combustion). Low NOx engines, such as gas and dual fuel and even diesel or gasoline engines push the limits of combustion in the direction of lean misfire, therefore, fast and accurate detection of poor fire and misfire can, in certain instances, facilitate responding and correcting for detected misfire and poor fire events so that engine performance is not hindered or the engine is not damaged.

One challenge is that as fuel quality and atmospheric conditions change, an engine controller can have a hard time maintaining proper air/fuel ratio (AFR richer than the lean misfire limit of the engine. Additionally, as spark plugs or fuel injectors are used for initiating combustion, but are prone to wear and eventually failure, misfire can also occur when the spark plug or injector is used beyond its useful life. It is therefore valuable to detect misfire quickly with high reliability. In some instances, misfire is associated with gas not burning and being discharged to the exhaust system. In extreme conditions, the gas in the exhaust pipe can be ignited by the engine, leading to an explosion that can damage the engine and the exhaust system. In engines with an after-treatment system, it is possible the explosion will destroy the after-treatment system. In greenhouses, this might be a selective catalytic reduction (SCR) system which can be very expensive to replace.

Current on-board solutions for misfire detection use either shaft speed deviation, exhaust port temperature sensors. Multiple problems exist with the traditional detection methods. For example, detecting misfire by monitoring shaft speed is a relative measurement and the settings must be calibrated for each type of engine which have various cylinder counts, inertias, and engine speeds. Detecting misfire by monitoring shaft speed is not a highly reliable method to detect instantaneous misfire. It requires a continuous status and accumulation of many cycles to provide a positive indicator of misfire—which may be too slow to detect misfire leading to exhaust system back-fire explosion.

Additionally, monitoring exhaust port temperature takes a number of misfire cycles to enable the exhaust temperature to fall due to lack of combustion, and therefore lacks the ability to quickly detect events or detect events in specific cylinders. This is hampered by the thermal mass of the thermocouple and the exhaust manifold. Moreover, exhaust temperatures go in different directions depending upon the failure mode, and can first go high, and then low, on the path to misfire. For example, when the fuel quality or AFR change in the direction of misfire, the exhaust temperature will actually increase during poor fire (due to late combustion) prior to dropping when true misfire occurs. Thus it can be difficult for the controller to first monitor the temperature increase and then look for a drop in temperature.

Finally, methods for detecting misfire and poor fire events using a heat release calculation include first calculating a pressure-derived heat release rate for misfire detection. Detection using the heat release calculation method is not adequate because heat release analysis is very poor when combustion is weak or non-existent. Additionally, a heat release window is often much more focused on crank angles close to top-dead-center (TDC) (e.g. −10° or −60° after TDC) where “good combustion” generally occurs. However, poor combustion can occur outside this window, where combustion is poor, but still occurs. Poor combustion may not be a condition that requires engine shut down, but rather engine control changes. It is desirable to know if poor combustion is occurring so that an engine control unit (ECU) can adjust AFR or ignition advance to “save” the combustion event. But if true misfire is detected, the engine should be shut down immediately (i.e., before a subsequent ignition attempt). A real-time detection resolution cannot be detected with traditional heat release methods.

Currently, combustion monitoring via cylinder pressure is used to develop engine combustion strategies and their control on nearly all engines in the research and development environment. However, cylinder pressure based monitoring systems on production engines remain underdeveloped and short on capability due to the low speed processors generally available in current production ECUs, and they are expensive and unreliable, thus limiting their applicability to only the highest power density and highest efficiency applications where their benefits can be justified against their cost. With new emerging ECU capability and more reliable pressure sensors, it is anticipated that widespread adoption of pressure sensing is imminent. However, once ECU capability and sensor reliability achieve their targets, their remains the need for “efficient and meaningful algorithms.” In this disclosure, one such efficient and meaningful algorithm is identified—that being the ability to quickly and with high reliability detect both Poor Fire and True Misfire on a cycle by cycle basis. Some example methods described herein are able to detect each and every misfire cycle as well as poor fire by sampling cylinder pressure during each combustion event and flagging each accordingly. Within this embodiment, the detection information is immediately transferred to the ECU to take corrective action on the first misfire or poor fire event.

Some of the concepts described herein encompass controlling an engine and detecting misfire and poor fire events using in-cylinder pressure measurements processed by an engine control unit (ECU). Concepts disclosed herein can provide an ability to detect poor fire and misfire events in a single engine cycle (i.e., before the next combustion even within the same combustion chamber) without the need for a high power processor, and in certain instances, without requiring a separate higher power ECU for processing the pressure signals into combustion metrics, such as heat release derived parameters, that resides apart from the ECU for determining and controlling the ignition timing and fueling. Using in-cylinder pressure measurements can, in some instances, eliminate the need for using multiple other sensors for engine control, for example, eliminating the need for a mass-air-flow sensor, NOx (oxides of nitrogen) sensor, knock sensor or exhaust temperature sensor. Moreover, in certain instances, the concepts herein enable better adapting to variations in fuel quality (e.g., variations in methane number (MN) and energy content (MBTU/m³)).

The ECU has an embedded processor with, in certain instances, the capability to process high-speed cylinder pressure data with resolution as fine as 0.25° crank and capable of producing a comprehensive suite of diagnostics for monitoring cylinder pressure, as well as, filtering and averaging combustion diagnostics in real-time, i.e., concurrent with the engine operation and current enough for use in a control loop for controlling the engine. In some instances, the processing and control is done within a single cycle of each cylinder. In some instances, the ECU is capable of processing up to 20 cylinders in real-time with the total processing time for each cylinder of around 2.5 milliseconds. The real-time combustion metrics calculated by the ECU, in certain instances, include location, in crank angle or time, of peak pressure (P_{loc}) and maximum pressure (Pₘₐₓ), and pressure at any specific fixed crank angle or volume within one or more the cylinders.

Prior art embedded pressure monitoring systems can be found in closed-loop control on a modern four-cylinder, reciprocating diesel engine, in both a conventional dual-fuel natural gas-diesel mode, and a Reactive Controlled Compression Ignition, or RCCI, gas-diesel mode—in a research lab environment. However, these concepts are not general and are not well applicable to any other engine configurations such as those with fewer or more cylinders, different fuel types, and to other, non-reciprocating types of engines. Concepts disclosed herein go beyond the research lab environment to be made practical in an embedded ECU.

According to the concepts herein, poor fire events and misfire events are able to be detected on a per cylinder and per engine cycle basis by monitoring engine cylinder pressure and monitoring engine shaft position (e.g., with a crank angle sensor and/or in another manner), smoothing and averaging the in-cylinder pressure at locations before and after an ignition event representing equal combustion chamber volumes (e.g., the same cylinder location before and after TDC), and comparing the difference between the before and after averaged pressure to a predetermined threshold value from the particular volumes measured that indicates negative combustion quality.

In some instances, the sensed pressure is processed using vector central average smoothing prior to use in an algorithm for the determination of inadequate combustion events. According to the embodiments herein, algorithms compare the exhaust stroke pressure against the compression stroke pressure at the same cylinder volume (referring to the P-V diagram) (typically, but not necessarily, the equal volume states can be characterized as equal absolute value of the engine crank angle relative to TDC (e.g., smoothed pressure at 90° after TDC on the exhaust stroke compared to 90° before TDC on the compression stroke and/or in another manner.)

According to the embodiments herein, calculation of the pressure difference between expansion stroke and compression stroke is input to an algorithm used to determine if each combustion event is “ok” or “not ok.”

Some aspects of the embodiments herein include a method using continuous monitoring of cylinder pressure for each cylinder. The method compares the pressure on the combustion stroke to the pressure on the compression stroke at the same engine crank angle. Aspects of the embodiments herein include a method selecting 1-5 key crank angles for comparison. In some instances, the key crank angles are preset and, in some instances, the key crank angles are varied during operation. Aspects of the embodiments herein include using appropriate smoothing and averaging of the pressure signal to reduce the effects of noise on the pressure trace. Aspects of the embodiments herein include, once an inadequate combustion event is detected by the ECU, triggering an alarm state signal that is available to the main ECU or main engine control algorithms that can shut-off fuel and ignition firing to protect the engine and avoid engine ignited exhaust explosions.

Aspects of the embodiments herein include a system configured to set an alarm flag in a main ECU or main controller in response to the determined combustion quality indication. According to the embodiments herein, a “Poor Fire Detected” alarm is flagged when the pressure due to combustion does not rise at or before the user specified window, for example, at or after 60° after TDC and/or in another manner. According to the embodiments herein, a “Misfire Detected” alarm is flagged when the pressure due to combustion does not rise at or before the user specified window, for example, at or after 90° after TDC. Aspects of the embodiments herein enable the following benefits: (i) improve misfire detection threshold to each misfire event, where no time averaging is required, (ii) faster combustion event quality detection than traditional methods, (iii) variable detection resolution on “Good fire”, “Poor fire” and true “Misfire” events, and (iv) eliminates dependency upon any engine (rpm, cylinder count), fuel, or combustion characteristics.

In some instances, the concepts herein encompass natural gas engines that employ cylinder pressure monitoring to determine the IMEP and center of combustion (CA50) as primary methods based upon new capabilities, such as heat release, while also being able to monitor and control on more conventional pressure only methods such as the magnitude and location of peak pressure and adjust ignition and fueling to balance the cylinders, while safely keeping the peak pressure below the engine design limits. One such in-cylinder pressure measure and combustion metric calculation system is disclosed in U.S. application Ser. No. 15/099,486, titled “Combustion Pressure Feedback Based Engine Control with Variable Resolution Sampling Windows.” Combustion parameters such as location of start of combustion (SOC), center of combustion (CA50), the rate of pressure rise (RPR), and maintaining Pₘₐₓ below the engine limit can be calculated, provided to the engine controller, and subsequently controlled near the limits of poor fire with feedback to modify engine control parameters upon the detection of even a single poor fire event using examples described herein.

For Homogeneous Charge Compression Ignition (HCCI), Premixed Charge Compression Ignition (PCCI), and Reactivity Controlled Compression Ignition (RCCI) and other low temperature combustion (LTC) modes, combustion quality indications can also be used to maintain key combustion parameters within specified limits. These combustion modes are quite un-stable and it would not be uncommon to have “poor fire” generally mistaken as “misfire” due to the wide variation in location of combustion. In some instances, methods disclosed herein can detect if the combustion event was poor-fire rather than misfire, because of the positive determination of the location where combustion starts can be refined, and the degree magnitude of control corrections can be adjusted according to the location of first detection of combustion (or crank angle where misfire ends with an actual combustion event). Accordingly, some embodiments include a “start of combustion” detection method as the point when misfire has ceased to be the combustion state.

Conventional methods which exist prior to this innovation include ECU system uses cylinder pressure monitoring fed directly into a controller and using the pressure ratio method—where in the peak pressure is compared to a pressure of the manifold or the cylinder just after intake valve closure, such that the ECU then adapts ignition-timing control and dilution control, to balance cylinders and conduct misfire and knock detection. Examples of the present system depart from the conventional method by processing the pressure trace across multiple crank-angles before and after TDC and converting it into multiple useful combustion quality indications, in certain instances, faster and more accurately than traditional engine speed or peak pressure only methods (i.e., peak pressure methods are used to avoid the need for precision crank angle determination). In certain instances, the speed advantage can come from using a high speed processor using efficient vectoring and the algorithms, which provide flexibility to wrap controls and diagnostics around specific pressure indications for various combustion quality metrics (e.g., good fire, poor fire, misfire). This is in contrast to the conventional methods which may only use the voltage of the pressure sensor or the voltage from a shaft encoder directly into a “one kind of control” engine controller.

In conventional ECU system, in some instances, due to memory and processor limitations, the analysis of a pressure trace can be limited to information customized to work directly with the engine control strategy and the processor for determining the combustion metrics is embedded in the same device as the remainder of the engine control unit. In a memory or processor limited implementation, the conventional ECU system selects only a small subset of the combustion metrics and uses surrogate analyses that are useful only for a one of a kind pre-designed engine control objective; they are not general.

In some examples of the present ECU system, it converts high-speed cylinder pressure data into meaningful low speed data that informs the user of the engine operating conditions (e.g., adequate or inadequate combustion) within a small number of engine cycles, even within a single cycle, and provides stable and reliable smart sensor input to the ECU to deliver the following benefits. In some instances, the pressure data supplied to the ECU system also enables engine protection via appropriate actuator changes to provide over-pressure protection (Pₘₐₓ), pressure rise rate protection (RPR), and knock detection. In some instances, the ECU system calculates combustion quality metrics (e.g., rate of poor fire or misfire) to determine the above actuator changes (e.g. ignition timing, in-cylinder injection and port injection timing and duration, AFR control, and throttle position.

In some examples, a system is built into an embedded controller that communicate with the main controller directly or over a controller area network (CAN) link, and without significant time lag. Alternatively, in some instances, one or more of the combustion quality detection methods described above are performed directly on the main processor of the ECU, assuming adequate computational power is available.

In some instances, the engine control device is configured to improve knock margin in gas engines, improve maximum gas-to-diesel substitution rates in a gas diesel dual-fuel application, and enable precise control of combustion phasing of an LTC strategy such as HCCI, RCCI, PCCI, all within the engine protection limits and improve efficiency at equal emissions or engine reliability.

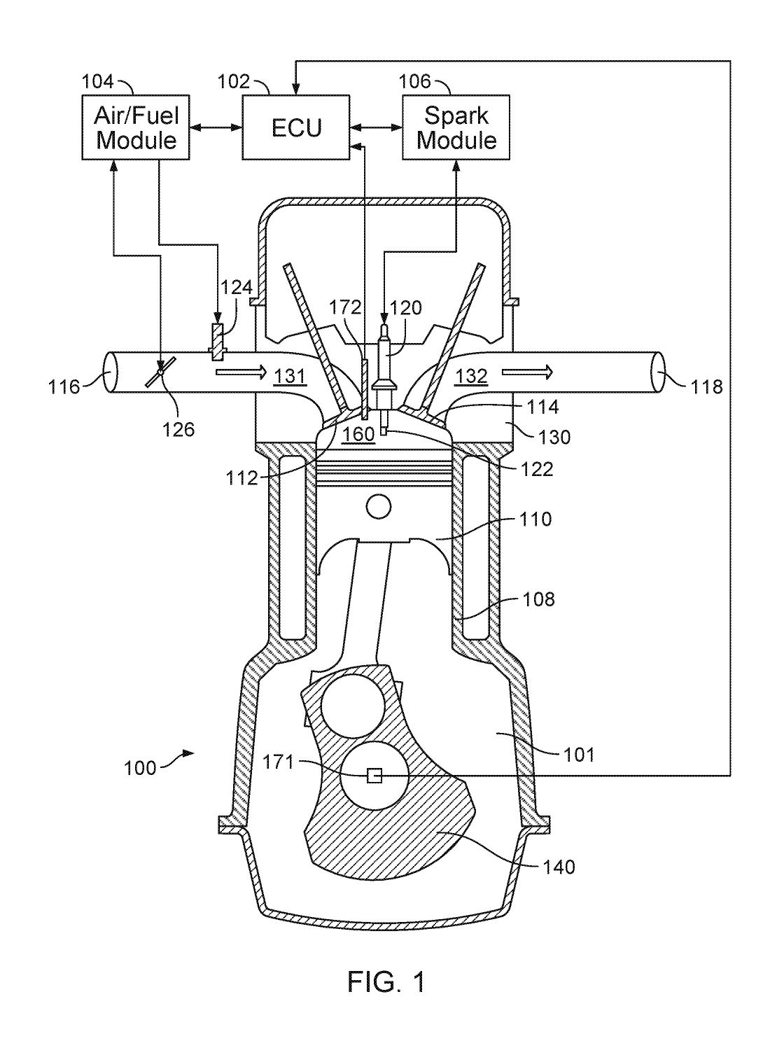

Referring initially to FIG. 1, an engine system 100 exemplifying the present system is shown. The engine system 100 includes an engine control unit 102, an air/fuel module 104, an ignition module 106, and an engine 101 (shown here as a reciprocating engine). FIG. 1 illustrates, for example, an internal combustion engine 100. For the purposes of this disclosure, the engine system 100 will be described as a gaseous-fueled reciprocating piston engine. In certain instances, the engine operates on natural gas fuel. The engine may be any other type of combustion engine, both in the type of fuel (gaseous, liquid (e.g., gasoline, diesel, and/or other), same phase or mixed phase multi-fuel, and/or another configuration) and the physical configuration of the engine (reciprocating, Wankel rotary, and/or other configuration). While the engine control unit 102, the air/fuel module 104 and the ignition module 106 are shown separately, the modules 102, 104, 106 may be combined into a single module or be part of an engine controller having other inputs and outputs.

The reciprocating engine 101 includes engine cylinder 108, a piston 110, an intake valve 112 and an exhaust valve 114. The engine 101 includes an engine block that includes one or more cylinders 108 (only one shown in FIG. 1). The engine 100 includes a combustion chamber 160 formed by the cylinder 108, the piston 110, and a head 130. A spark plug 120 or direct fuel injector or prechamber is positioned within the head 130 which enables the ignition device access to the combustible mixture. In general, the term “spark plug” can refer to a direct fuel injection device and/or spark plug or other ignition device within a prechamber. In the case of a spark plug, a spark gap 122 of the spark plug 120 is positioned within the combustion chamber 160. In some instances, the spark gap 122 is an arrangement of two or more electrodes with a small space in-between. When an electric current is applied to one of the electrodes, an electric arc is created that bridges the small space (i.e., the spark gap) between the electrodes. Other types of igniters can be used, including laser igniters, hot surface igniters and/or yet other types of igniters. The piston 110 within each cylinder 108 moves between a top-dead-center (TDC) position and a bottom-dead-center (BDC) position. The engine 100 includes a crankshaft 140 that is connected each piston 110 such that the piston 108 moves between the TDC and BDC positions within each cylinder 108 and rotates the crankshaft 140. The TDC position is the position the piston 110 with a minimum volume of the combustion chamber 160 (i.e., the piston's 110 closest approach to the spark plug 120 and top of the combustion chamber 160), and the BDC position is the position of the piston 110 with a maximum volume of the combustion chamber 160 (i.e., the piston's 110 farthest retreat from the spark plug 120 and top of the combustion chamber 160).

The cylinder head 130 defines an intake passageway 131 and an exhaust passageway 132. The intake passageway 131 directs air or an air and fuel mixture from an intake manifold 116 into combustion chamber 160. The exhaust passageway 132 directs exhaust gases from combustion chamber 160 into an exhaust manifold 118. The intake manifold 116 is in communication with the cylinder 108 through the intake passageway 131 and intake valve 112. The exhaust manifold 118 receives exhaust gases from the cylinder 108 via the exhaust valve 114 and exhaust passageway 132. The intake valve 112 and exhaust valve 114 are controlled via a valve actuation assembly for each cylinder, which may include be electronically, mechanically, hydraulically, or pneumatically controlled or controlled via a camshaft (not shown).

Movement of the piston 110 between the TDC and BDC positions within each cylinder 108 defines an intake stroke, a compression stroke, a combustion or power stroke, and an exhaust stroke. The intake stroke is the movement of the piston 110 away from the spark plug 120 with the intake valve 112 is open and a fuel/air mixture being drawn into the combustion chamber 160 via the intake passageway 131. The compression stroke is movement of the piston 110 towards the spark plug 120 with the air/fuel mixture in the combustion chamber 160 and both the intake value 112 and exhaust valve 114 are closed, thereby enabling the movement of the piston 110 to compress the fuel/air mixture in the combustion chamber 160. The combustion or power stroke is the movement of the piston 110 away from the spark plug 120 that occurs after the combustion stroke when the spark plug 120 ignites the compressed fuel/air mixture in the combustion chamber by generating an arc in the spark gap 122. The ignited fuel/air mixture combusts and rapidly raises the pressure in the combustion chamber 160, applying an expansion force onto the movement of the piston 110 away from the spark plug 120. The exhaust stroke is the movement of the piston 110 towards the spark plug 120 after the combustion stroke and with the exhaust valve 114 open to allow the piston 110 to expel the combustion gases to the exhaust manifold 118 via the exhaust passageway 118.

The engine 100 includes a fueling device 124, such as a fuel injector, gas mixer, or other fueling device, to direct fuel into the intake manifold 116 or directly into the combustion chamber 160.

In some instances, the engine system 100 could include another type of internal combustion engine 101 that doesn't have pistons/cylinders, for example, a Wankel engine (i.e., a rotor in a combustion chamber). In some instances, the engine 101 includes two or more spark plugs 120 in each combustion chamber 160.

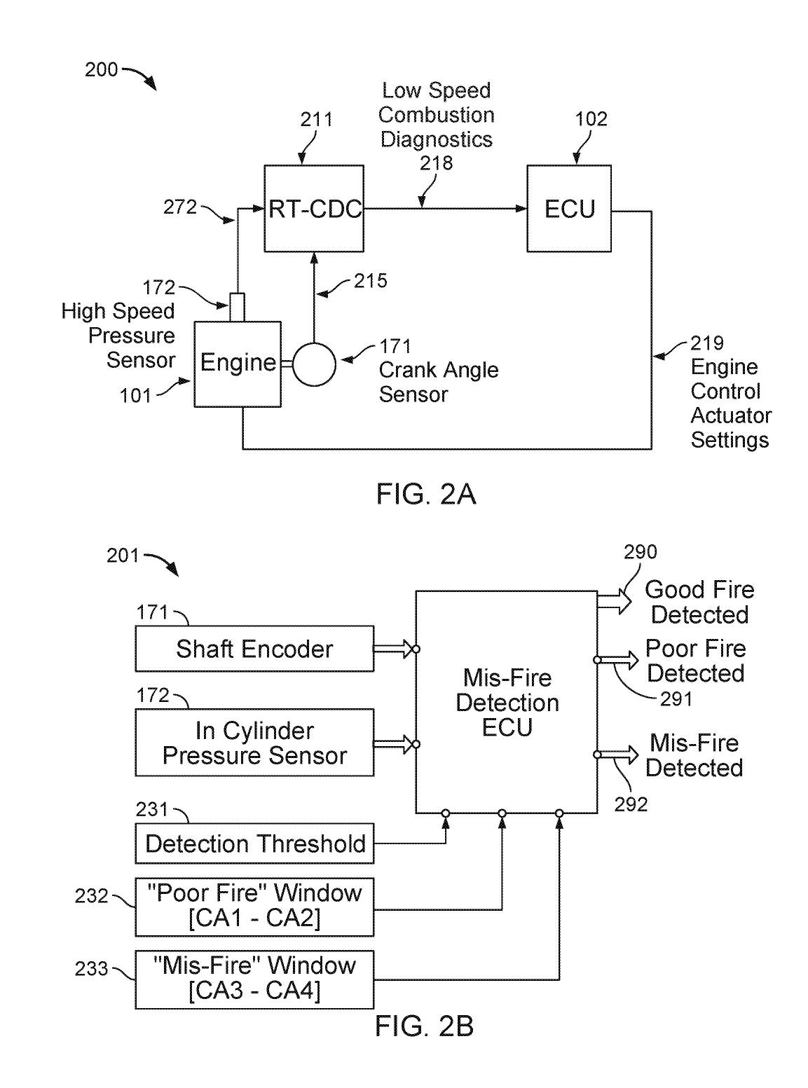

During operation of the engine, i.e., during a combustion event in the combustion chamber 160, the air/fuel module 104 supplies fuel to a flow of incoming air in the intake manifold before entering the combustion chamber 160. The spark module 106 controls the ignition of the air/fuel in the combustion chamber 160 by regulating the timing of the creation of the arc the spark gap 122, which initiates combustion of the fuel/air mixture within combustion chamber 160 during a series of ignition events between each successive compression and combustion strokes of the piston 110. During each ignition event, the spark module 106 controls ignition timing and provides power to the primary ignition coil of the spark plug 120. The air/fuel module 104 controls the fuel injection device 124 and may control throttle valve 126 to deliver air and fuel, at a target ratio, to the engine cylinder 108. The air/fuel module 104 receives feedback from engine control module 102 and adjusts the air/fuel ratio. The spark module 106 controls the spark plug 120 by controlling the operation of an ignition coil electrically coupled to the spark plug and supplied with electric current from a power source (both shown in FIG. 2A). The ECU 102 regulates operation of the spark module 106 based on the engine speed and load and in addition to aspects of the present system disclosed below.

In some instances, the ECU 102 includes the spark module 106 and the fuel/air module 104 as an integrated software algorithms executed by a processor of the ECU 102, and thereby operate of the engine as single hardware module, in response to input received from one or more sensors (not shown) which may be located throughout the engine. In some instances, the ECU 102 includes separate software algorithms corresponding to the described operation of the fuel/air module 104 and the spark module 106. In some instances, the ECU 102 includes individual hardware module that assist in the implementation or control of the described functions of the fuel/air module 104 and the spark module 106. For example, the spark module 106 of the ECU 102 may include an ASIC (shown in FIG. 2A) to regulate electric current delivery to the ignition coil (also shown in FIG. 2A) of the spark plug 120. A plurality of sensor systems exist to monitor the operational parameters of an engine 100, which may include, for example, a crank shaft sensor, an engine speed sensor, an engine load sensor, an intake manifold pressure senor, an in-cylinder pressure sensor, etc. Generally, these sensors generate a signal in response to an engine operational parameter. For example, a crank shaft sensor 171 reads and generates a signal indicative of the angular position of crankshaft 140. In an exemplary embodiment, a high speed pressure sensor 172 measures in-cylinder pressure during operation of the engine 100. The sensors 171,172 may be directly connected to the ECU 102 to facilitate the sensing, or, in some instances are integrated with a real-time combustion diagnostic and control (RT-CDC) unit configured to acquire high speed data from one or more of the sensor and provide a low speed data output to the ECU 102. In some instances, the ignition control described herein is a stand-alone ignition control system providing the operation of ECU 102 and the spark module 106. The sensors may be integrated into one of the control modules, such as the ECU 102 or a RT-CDC. Other sensors are also possible, and the systems described herein may include more than one such sensor to facilitate sensing the engine operational parameters mentioned above.

FIG. 2A is a schematic of an engine control system 200 of the engine system 100 of FIG. 1. FIG. 2A shows the ECU 102 within the engine control system 200 configured to control the engine 101. As indicated above, high-speed pressure data 272 is generated by pressure sensors 172, each mounted with direct access to the combustion chamber. The pressure signal 272 is captured at a high crank-synchronous rate, for example, 0.25° resolution or 2880 samples per cycle of the engine 101. This synthetic crank angle signal is generated from the lower resolution crank position signal. For example, with a typical crank angle encoder 171 generating a crank angle signal 215 by sensing passage of the edge of teeth on a disk, the disk mounted to rotate with the crank, the resolution of the crank position is based on the number of teeth. A typical 60-2 tooth wheel has a resolution of 6°. However, in some instances, interpolation is used to determine a crank angle in the space between of the edges. Thus, the spacing between edges uses the previously observed tooth period divided by the number of edges required to achieve the desired angular sampling resolution. To account for minor variability between the crank teeth that can be seen even when the average engine speed is constant, and the encoder system is re-synchronized on each edge.

In some instances, the resulting high-resolution pressure signal 272 is used by the combustion diagnostics routine in the ECU 102 to produce the combustion diagnostics 219 on a per-cylinder, per cycle basis, for example, IMEP, Pₘₐₓ, CA50, and combustion quality (e.g., good fire, poor fire, misfire). The metrics 218 are subsequently used by the ECU 102 as a feedback signal for adjusting key combustion performance characteristics by modulating engine control actuator settings 219. In an exemplary embodiment, the crank angle signal 215 is used to analyze the pressure signal 272 at crank angles before TDC and after TDC (e.g., two equal main combustion chamber 160 volumes) during each combustion event, and, based on a comparison of the difference between the two pressure signals to a threshold value associated with the sampled crank angle or range of crank angles, determine if each combustion event in the main combustion chamber 160 of the engine 101 exhibits poor fire or misfire.

In conventional (non-LTC) dual-fuel operation, combustion phasing is a critical factor for efficiency, emissions, and knock margin. Good control of combustion phasing can significantly improve the maximum gas substitution rate. As not all variables in the engine can be held to tight tolerances (including manifold absolute temperature (MAT), manifold absolute pressure (MAP), and injection rail pressure for example), typical open-loop methods of controlling combustion phasing can be significantly enhanced by some feedback mechanism.

Reactivity Controlled Compression Ignition (RCCI) is a one of many LTC strategies to dramatically reduce NOx production and simultaneously achieve fast combustion of lean mixtures to improving efficiency. In RCCI, two fuels of different reactivity are introduced early into the combustion chamber to adjust the phasing of combustion initiation and rate of combustion. In gas-diesel RCCI, natural gas is injected into the intake port and diesel is injected directly into the combustion chamber. With diesel common rail, it is possible to inject the diesel portion at various times and quantities up to the limitations of the injection system. Typically, the diesel is injected much earlier than normal diesel or gas-diesel dual-fuel as early as just after intake valve closing (IVC) to as late as 70° before top dead center (BTDC, where TDC is the crank position at which the piston is in its top most position within the cylinder). Additionally, the ‘gain’ switches sign, where in RCCI, earlier diesel timing leads to later combustion phasing—which is the opposite of diesel and dual-fuel combustion where earlier diesel leads to earlier combustion phasing.

FIG. 2B is an input-output schematic 201 of an engine control unit 102 showing sensor inputs from the shaft encoder 171 and the in-cylinder pressure sensor 172, combustion metric outputs 291, 291, and parameter inputs 231-233. The ECU 102 could be the same ECU 102 as shown in FIGS. 1 and 2A, or it could another embodiment. The ECU 102 inputs data from the shaft encoder 171 (e.g., a crank angle sensor), and the in-cylinder pressure sensor 172, and outputs a combustion quality indication, which includes an indication of good fire 290, poor fire 291, or misfire 292. FIG. 2B shows the ECU 102 accepting two volume range windows 232, 233, where the first represents a poor fire detection window 232 of equal cylinder volumes and the second represent a misfire detection window 233 of equal cylinder volumes. In some instances, multiple volume range windows are used. In some instances, the equal cylinder volume windows correspond to equal crank angle ranges before and after TDC, for example −61° to −59° (i.e., before TDC) and 59° to 61° (i.e., after TDC). The ECU 102 also accepts detection threshold for use in determining the indication of the pressure signal in each of the indicated windows 232, 232. The ECU 102 determines a combustion quality indication by sampling the in-cylinder pressure at specific cylinder volumes ranges before and after an ignition event, calculating the difference (i.e., pressure rise after the ignition event at during the volume range), and comparing the difference to the detection threshold. In some instances, the detection threshold represents a pressure difference, and in some instances the detection threshold is the same for both windows 232, 233, and in other instances a different detection threshold is used for each window. In some instances, the ECU 102 controls the engine 101 based on the combustion quality indication by outputting one or more of a throttle position signal, a timing advance signal, and a fuel rate signal.

FIG. 2C shows an example flow diagram of the internal operation of the ECU 102 of system 100. While shown as single ECU, in other instances, the ECU 102 can be an ECU with a separate a data bus in addition, and have a common processor or separate processors for the combustion metric determination and the engine control. FIG. 2C shows the ECU 102 accepting inputs from the shaft encoder 171 (e.g., crank angle) and the in-cylinder pressure sensor 172. The shaft encoder 171 need not be a high resolution sensor, and in certain instances, it can be a sensor reading a 60-2 tooth wheel. For each cylinder, the ECU 102 calculates combustion quality indications 290, 291, 292 from the input data 171, 172. In the ECU 120, for each cylinder, the following steps are executed in, for example, a pressure sensor processing module. First, at step 241, all constants are defined, including vectors via engine geometry. In some instances, this step 241 is incorporate into the programming prior to the execution of the following step. Next, at step 242, the in-cylinder pressure is captured, in some instances, at a specified sampling rate defined by a sampling rate window. In some instances, pressure data is captured at a higher rate during one or more of the volume windows 232, 233, or, in some instances, is only captured during the volume windows 232, 233.

Next, at step 243, the raw pressure data is smoothed and averaged across a sampling range. In some instances, multiple sampling ranges are used. In some instances, raw pressure data is captured, smoothed, and averaged across a first volume range of a volume window 232, 233 and captured, smoothed, and averaged across a second range of the same volume window 232, 233. In some instances, a first volume range of the volume window 232, 233 is crank angles from −61° to −59° during the compression phase and the second range of the same volume window 232, 233 are the corresponding crank angles of 59° to 61° during the expansion phase. Next, at step 244, for the poor fire volume window, the difference between the pressure averages sampled during the compression range and the expansion range is calculated and compared to a detection threshold. Next, at step 245, for the misfire volume window, the difference between the pressure averages sampled during the compression range and the expansion range is calculated and compared to a detection threshold.

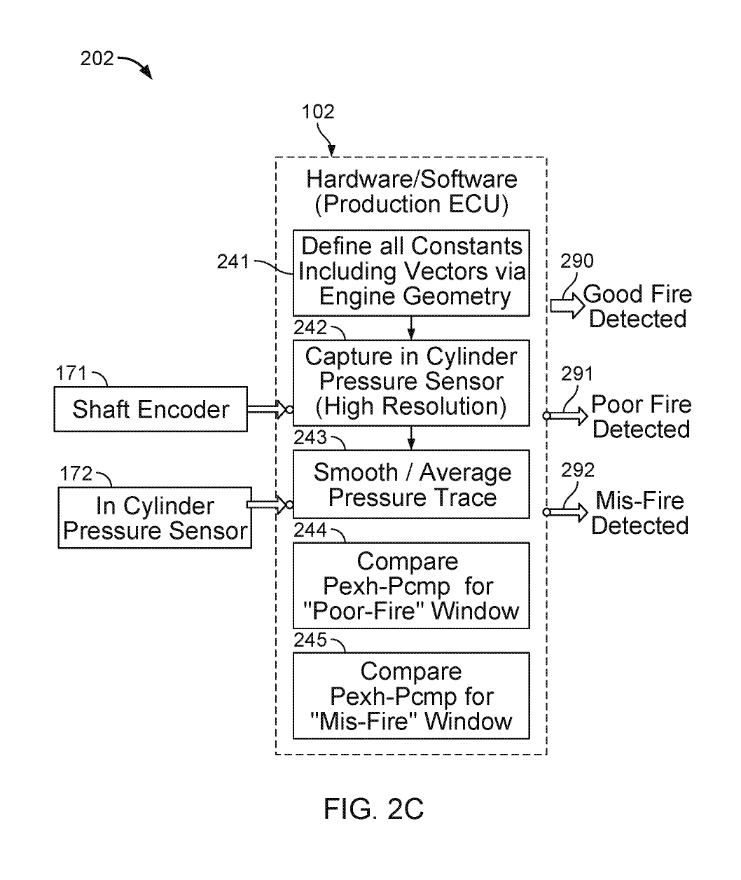

Finally, based on the results of the two comparison steps 244, 245, the ECU 102 generates a combustion quality indication 290-392. For example, if both the calculated pressure difference in the poor fire and misfire windows 232, 233 are greater than their corresponding threshold values 231, the ECU 102 indicates good fire 290 for that specific combustion event. If the calculated pressure difference in only the poor fire window 232 is less than the threshold, the ECU 102 indicates poor fire 291. Finally, if the calculated pressure difference in both the poor fire and misfire windows 232, 233 are less than their corresponding threshold values 231, the ECU indicates misfire 292. In some instances, as shown in more detail below in FIGS. 3, 4, and 8A-10B, the ECU 102 samples pressure at equal cylinder volumes, where the cylinder volume is the thermodynamic volume and is at least partially a function of crank angle. In some instances, equal crank angles (i.e., before and after TDC) will result in equal thermodynamic volume, but most instances the thermal dynamic volume must be calculated, even though this requires extra memory and computational power.

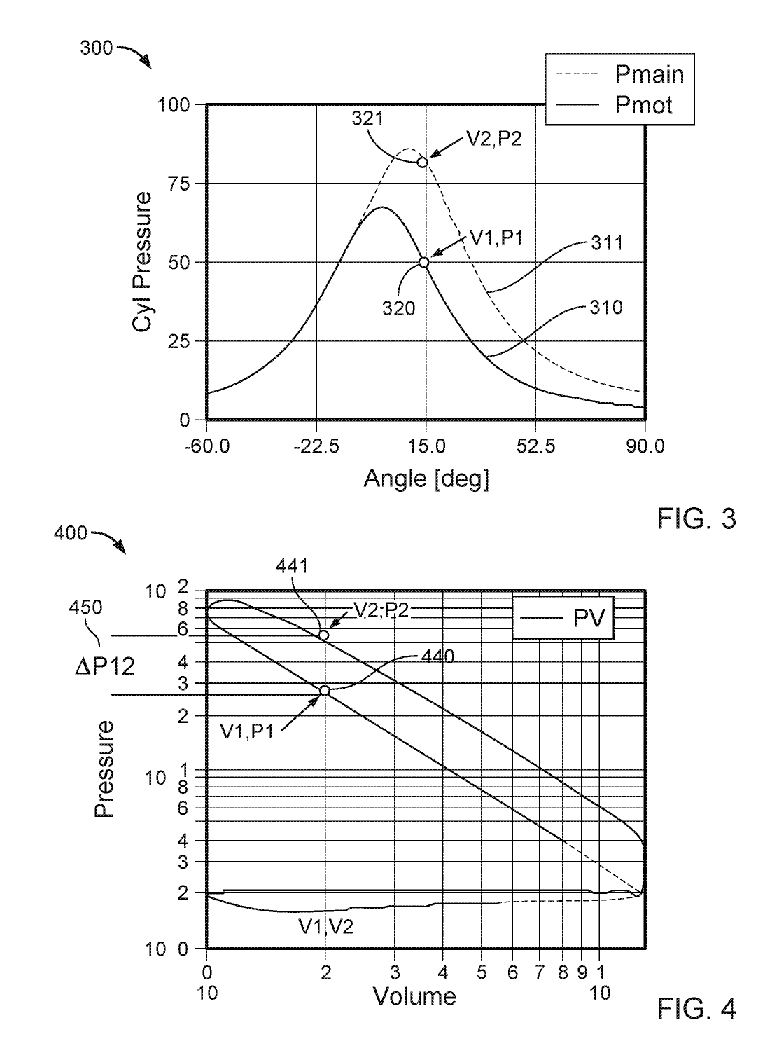

Referring now to FIGS. 3 and 4. FIG. 3 is a graph 300 showing a curve 311of a pressure trace vs. crank angle of a combustion event in a cylinder plotted with a curve 310 of the compression of the cylinder before combustion, where FIG. 4 is a pressure vs. volume (PV) graph 400 for the same combustion event of FIG. 3. In FIG. 3, a first point 320 is the pressure at a specific volume on the compression curve 311. A second point 321 is the pressure at a specific volume on the expansion curve 310. In FIG. 3, the compression curve 310 is duplicated on the expansion side of the CA range (i.e., the x-axis), which makes it easier to see that with combustion the pressure at the second point 321, is above the compression pressure at the first point 320 at the same crank angle, giving a positive indication of combustion at this point in the cycle.

In FIG. 4, the first point (320 of FIG. 3) is shown on the PV graph 400 as point 440, and the second point (321 of FIG. 3) is shown on the PV graph 400 as point 441. Also shown, is a difference 450 (i.e., ΔP) between the two points 440, 441 at their equal volume.

In operation, the volumes (e.g., thermodynamic volume or cylinder volume) of the first and second points 320, 321 are equal and this equivalence is used to determine when each point is sampled. Once sampled, a comparison is made between the expansion curve 311 pressure, (at the second point 321), to the compression curve 310 pressure (at the first point 320). The difference 450 is process to determine the combustion indicator. For example, if the second point 321 is greater than the first point 320 plus a threshold value, then a flag is set “combustion at V2” (where V2 represents the volume at the second point 321) which means good combustion. If the second point 321 is less than or equal to the first point 320 plus the threshold, then the flag is set “no combustion at V2”. In some instances, an operator or programmer has the freedom to set one or more volumes for expansion to compression curve comparisons by setting an examination volume. In practice, in general, most engines have symmetric crank shafts, so that the volume is determined by the crank angle, so it is possible to substitute crank angle for the volumes of each point, such that the crank angle of the first point 320 is equal to the crank angle of the second point 321. However, this is a special case of the more general specification of “comparison at equal volumes”.

Referring to FIG. 4, the pressure during the post combustion expansion phase at a discrete volume (i.e., the second point 441), is compared against the pressure during the compression stroke at the same discrete volume (i.e., the first point 440). In operation, the controller 102 aligns the measurements 440, 441 so that the expansion stroke volume is equal or equivalent to the compression stroke volume by equating. Thus, if there is combustion at this volume, the second point 441 will be greater than the first point 440 by some threshold quantity. In some instances, this threshold is adjusted to account for measurement error and noise. If this condition is met, then combustion is assumed to have taken place at or before the volume of the first and second points 440, 441. If combustion fails to be evident by this condition, then the controller 102 will flag this as a failure to combust or “misfire” up this volume.

In some instances, the processor further compares additional volumes later in the expansion stroke and makes the same comparison. If at none of the sample locations is there evidence of combustion via the above condition, then “true misfire” is detected and the ECU 102 alarms accordingly. If, however, at least at one of the sample locations the pressure condition (e.g., the second point 441) is met, then the minimum status of the combustion would be classified as “poor fire”. If all of the subsequently measures pressures meet the combustion condition above, then the combustion would be classified as “good fire”. Extra ECU 102 memory and CPU time are required to calculate the volume at each engine crank angle. In some instances, an ECU 102 is provided with extra capability to generate this volume calculation from a given bore, stroke, and compression ratio or equivalent.

In some instances, the results of the per-cylinder combustion quality indication are fed to an engine actuator control module of the ECU 102, where spark timing, throttle setting and fuel rate can be adjusted in response to the combustion quality indication. In some instances, the ECU 102 triggers an alarm if poor fire or misfire is detected, and the alarm may be relayed to a remote monitoring system by wired and wireless methods. In some instances, misfire results from electrical problems in the ignition system (e.g., low spark current), and, upon a detection of a misfire event, the ECU 102 directs the engine system 100 to reduce the load on the engine 101 and/or advances spark timing, and waits to see if another misfire event occurs. In some instances, if misfire events persist under reduced load or modified spark timing, the ECU 102 shuts down the engine 101 (e.g., by cutting fuel, ignition and/or otherwise) to prevent damage. In some instances, detected misfire or poor fire events are counter and averaged over time, and, based on the average, the ECU may adjust the engine control parameters or set and alarm. In some instances, if a threshold rate of poor fire and misfire events is surpassed during operation (e.g., greater than 1 poor fire event detected per 100 cycles, or greater than 1 misfire event detected by 10,000 cycles), the ECU 102 adjust one or more engine control parameters based on the rate of occurrence and/or the type of bad combustion occurrence. In some instances, high resolution triggering (e.g., 0.25° CA resolution) is provided from a low resolution encoder (e.g., a sensor reading a 60-2 tooth wheel), by using linear interpolation.

Optionally, and as discussed in more detail below, the ECU 102 can employ a high efficiency processing method that enables real-time poor fire and misfire detection per each cylinder for each cycle, while being fit in a standard “automotive” production ECU (with maximum allowable processor and memory). In particular, in some instances, the vector of pressure readings from the cylinder pressure sensor is sampled at different resolutions based on where the cylinder is in the combustion cycle. Thus, the vector is sampled at the highest resolution during only the poor fire and misfire windows 332, 333, and the total amount of data processed is reduced. Also, the data is collected and processed from the same memory for all cylinders.

In some instances, monitoring each combustion event for poor fire and misfire occurs simultaneously with control of a combustion phasing metric, for example centroid of heat release (CA50, a metric derived from high speed processing of heat release rate for every cycle), is conducted with actuation of combustion triggering phasing (e.g., spark advance or diesel start of injection) concurrently with simultaneous control of a combustion energy metric (e.g., IMEP). In some instances, this simultaneous control is achieved though actuation of total fuel quantity, either in-cylinder, in a diesel configuration, or extra-cylinder in, for example, in-port injection of natural gas or gasoline.

In some instances, the system computes combustion stability (COV of IMEP) and uses this stability calculation to determine a lean misfire air-fuel-ratio. Once lean misfire AFR is known, air fuel ratio controller is set to keep charge richer than misfire limit by a given margin and combustion phasing control is used to maintain best efficiency or input a NOx signal to retard timing to maintain NOx below its limit.

In some instances, the system adapts to changing gas quality during engine operation, without the need for a gas quality sensor, by using the combustion quality feedback instead.

Typical gas engines today, for example natural gas engines, are operated with fixed spark timing along with an in-factory calibration for AFR. This typical configuration may provide a good knock margin and meet emissions norms on a firing engine put into operation. However, for some engines, the spark timing and AFR are set such that the center of combustion or CA50 (time of 50% fuel burn) are maintained in a relatively retarded location between 15° and 20° ATDC. These settings are considered conservative and are set such that the worst envisioned fuel gas quality would not lead to engine damaging knock. In this type of calibration, a provided knock sensor is utilized only in extreme conditions; otherwise, the knock signature is relatively low. The result of this configuration is that while meeting NOx emissions norms, engines running with ‘good fuel’ (i.e., having low knock tendency by virtue of a high methane number (MN)) are running with a less-than-optimal fuel consumption during most or all of the time they are in operation. This loss of potential fuel economy can be, for example, as high as 1-4%.

Additionally, when fuel quality or AFR goes in the opposite direction, that is, leading toward poor combustion and misfire, typically the only method of detection on existing engines is by monitoring cylinder exhaust port temperatures. However, this leads to an ambiguous monitored condition, as high temperatures indicated late combustion while very low temperatures indicate misfire. Misfire is also indicated by instantaneous shaft speed variations, which can be used to corroborate a low temperature reading as a diagnostic of misfire.

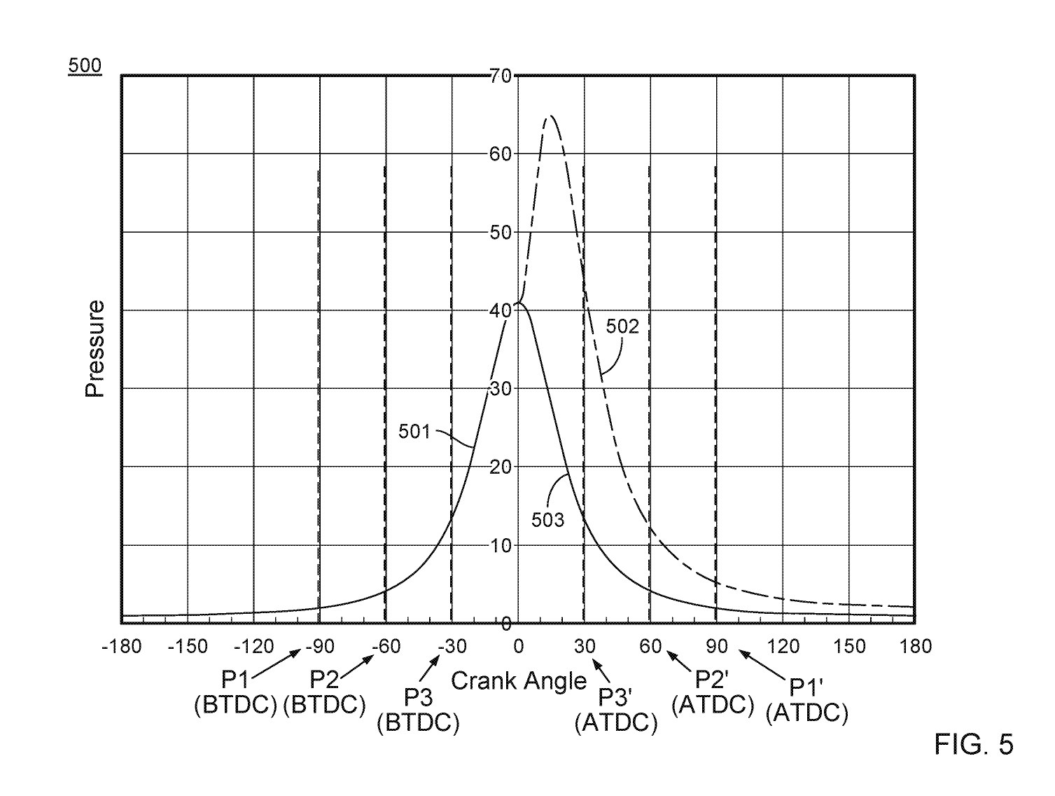

FIG. 5 is graph 500 of an in-cylinder pressure trace 502 of a nominal combustion event in a cylinder plotted against non-combustion pressure traces 501, 503 (e.g. compression stroke pressure 501 and expansion stroke pressure 503 without ignition) of the main combustion chamber 160. In some instances, the compression stroke pressure 501 is a sampled in-cylinder pressure before TDC, and the illustrated non-combustion expansion stroke pressure 503 is a reflection of the compression stroke pressure 501. In some instances, the non-combustion pressure traces 501, 503 are isentropic pressure data stored in a database accessible by the ECU 102. Hereinafter, the non-combustion pressure traces 501, 503 are simply referred to as the non-combustion pressure. FIG. 5 shows the TDC position at a 0° crank angle, where the nominal cylinder pressure 502 before TDC is the non-combustion pressure 501, because no combustion has occurred. At 0° , an ignition event occurs and the nominal in-cylinder pressure 502 increases due combustion. As the crank angle increases after combustion, the in-cylinder pressure 502 decreases as the volume of the main combustion chamber 160 increases with increasing crank angles. Overlaid on the graph 500, are three example measurement points P1, P2, P3, symmetrical disposed before and after TDC. In some instance, the measurement locations P1, P2, P3 represent single-instance sampling of the in-cylinder pressure 502, for comparison to the non-combustion pressure 503 at the sampled measurement locations P1, P2, P3. In other instances, the measurement points P1, P2, P3 represent a range of crank angles around the measurement locations P1, P2, P3 that are sampled, smoothed, and averaged prior to comparison to a similarly averaged range of the non-combustion pressure 503. The illustrated measurement points P1′, P2′, P3′ represent after TDC locations, but are referred to also as P1, P2, P3 for simplicity. In some instances, the after TDC locations P1′, P2′, P3′ represent locations of equal volume with respect to their corresponding locations P1, P2, P3 before TDC.

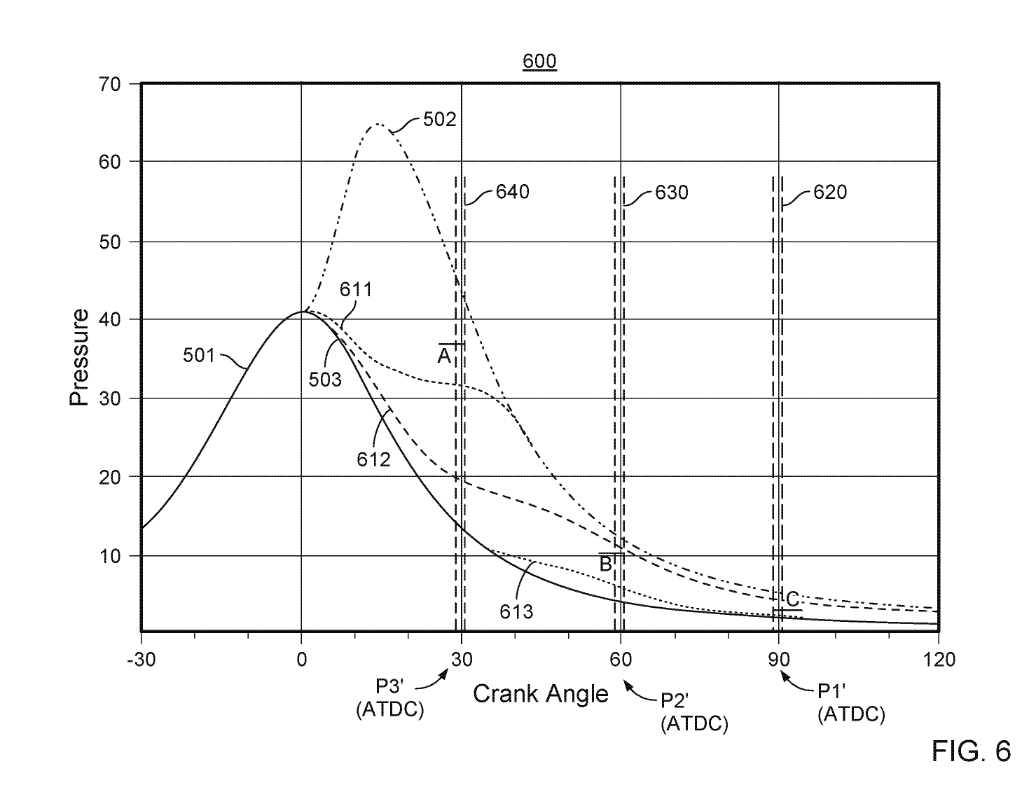

FIG. 6 is the graph 600 of FIG. 5, including pressure traces 611, 612, 613 of different inadequate combustion events and example detection windows 620, 630, 640 corresponding to the measurement locations P1, P2, P3 of FIG. 5. FIG. 6 shows three inadequate combustion events overlaid on the data of FIG. 5. First, a poor fire pressure 611 exhibits a late pressure rise (i.e., after TDC), and eventually reaches an adequate pressure condition 502 at a crank angle around 40°. Next, a second poor fire pressure 611 exhibits a very late-pressure rise (i.e., well after TDC), without reaching an adequate pressure condition 502 by the end of the expansion stroke (i.e.,)90°. Finally, a misfire pressure 612 shows a very late and minor pressure rise above the non-combustion pressure 503, that has a minimal effect on the main combustion chamber 160 pressure at the end of the expansion stroke. In some instances, a misfire event will not result in any pressure rise because, for example, the ignition event never occurred, or the ignition event did not initiate any combustion.

The detection windows 620, 630, 640 represent crank angle ranges over which the in-cylinder pressure sensor 172 is sampled. In this manner, while the pressure traces 502, 611, 612, 613 represent the actual in-cylinder pressure during the various combustion events, the ECU 102, in some instances, only receives pressure 214 data sampled during the detection windows 620, 630, 640. In operation, the pressure traces 502, 611, 612, 613 are sampled during the detection windows 620, 630, 640 by the in-cylinder cylinder pressure sensor 172, and raw pressure data for each detection window 620, 630, 640 is smoothed and averaged to generate a comparison pressure value, from which the non-combustion pressure 503 (during the corresponding detection window 620, 630, 640) is subtracted. In other instances, a pressure difference for each detection windows 620, 630, 640 is calculated, where the pressure difference represents the sampled pressure 502, 611, 612, 613 subtracted by the non-combustion pressure 503.

Threshold values A, B, C are provided for each of the detection windows 620, 630, 640 to determine a combustion quality indication for each of the combustion pressure traces, 502, 611, 612, 613,. While the threshold values A, B, C are illustrated in the graph 600 as having corresponding pressure values, in some instances, the threshold values A, B, C represent pressure ratios (i.e., A represents a 1.75 magnitude increase of the non-combustion pressure 503 in the P3 window 640). In other instances, the threshold values A, B, C represent pressure differences (i.e., A is shown as a 23 pressure value increase above the non-combustion pressure 503 in the P3 window 640).

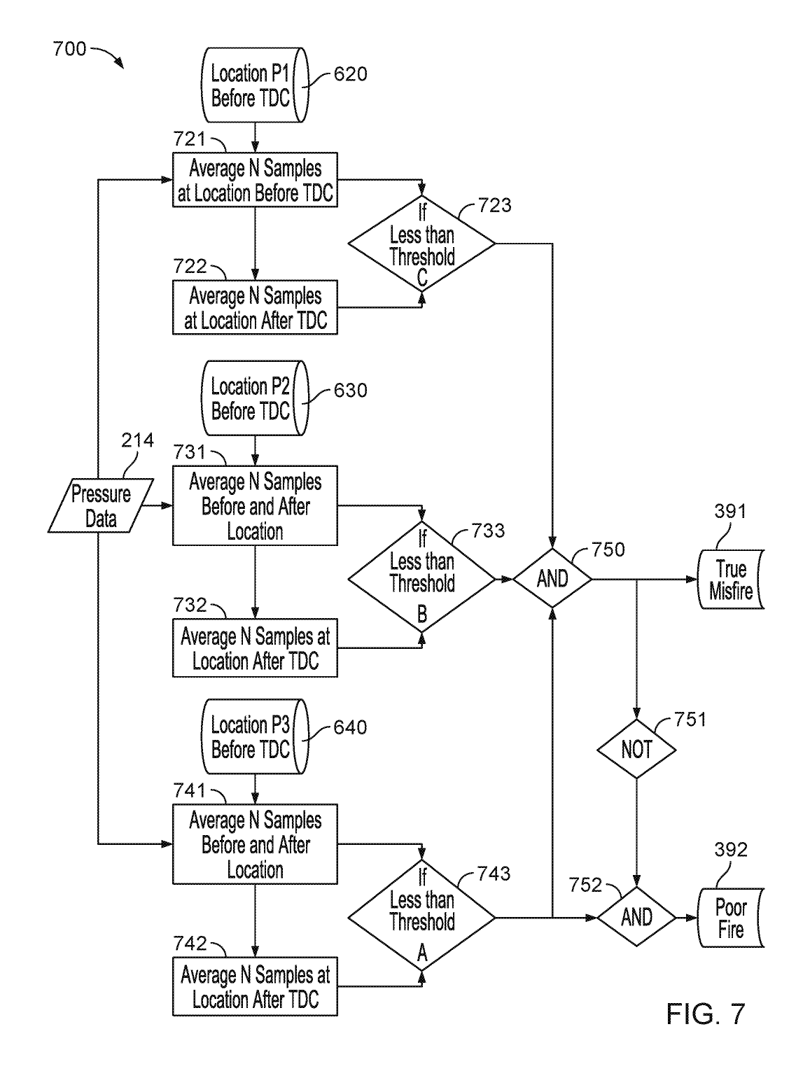

In operation, and as illustrated algorithmically in FIG. 7, the data of each combustion pressure trace, 502, 611, 612, 613 is compared to the threshold values A, B, C in each detection windows 620, 630, 640 and a detection profile is created for each combustion pressure trace, 502, 611, 612, 613, which indicates if the combustion pressure trace, 502, 611, 612, 613 is above or below the threshold value A, B, C in each detection window 620, 630, 640. Based on the detection profile, a combustion quality indication is generated for each combustion pressure trace, 502, 611, 612, 613. As shown, the first and second poor fire pressures 611, 612 are below the P3 threshold A, but above the P2 threshold B and the P3 threshold C. In contrast, the misfire pressure 612 is below all three thresholds A, B, C, and the nominal combustion pressure trace 502 is above all three thresholds A, B, C. The thresholds A, B, C and detection windows 620, 630, 640 are all adjustable, and fine-tuning of their values changes the detection profiles (i.e., above or below the thresholds) for each combustion pressure trace, 502, 611, 612, 613. For example, if threshold B is increased, the second poor fire pressure 612 may no longer be below the threshold B in the P2 detection window 630, which changes the profile from “below, above, above,” to “below, below, above,” with respect to the P3, P2, and P1 detection windows 620, 630, 640.

FIG. 7 is a flow chart 700 of the misfire and poor fire detection algorithm implemented in the ECU 102 to generated the combustion quality indication 390, 391, 392 based on the received pressure data 214. Pressure data 214 from a single in-cylinder pressure sensor 172 is input to the operation 700 from the three locations P1, P2, P3, corresponding to the three detection windows 620, 630, 640. In some instances, this process can be repeated for a pressure sensor associated with each cylinder, some of the cylinders, or the system can rely on data from one cylinder. In some instances, and as shown, the pressure 214 may be sampled 721, 731, 741 at the three locations P1, P2, P3 prior to combustion. In other instances, a stored isentropic value is used instead, which may be calibrated based on sensed operational engine parameters, such as engine temperature or engine speed. Continuing, the pressure data 214 is sampled after combustion 722, 732, 742 at the corresponding locations P1′, P2′, P3′. For each location P1, P2, P3, the sampled pressure before TDC 721, 731, 741, is subtracted from (or otherwise compare to) the sampled pressure after TDC 722, 732, 742 and compared 723, 733, 743 to the corresponding threshold value A, B, C. Each comparison 723, 733, 743 outputs a true or false value.

A first AND operator 750 determines true misfire 391, if all comparisons 723, 733, 743 return false (i.e., below the threshold A, B, C as shown in FIG. 6 for the misfire pressure 613). A second AND operator 752 determines poor fire 392, if the P3 comparison 743 is false (i.e., below threshold A as shown in FIG. 6) and if, using a NOT operator 751, one of the other comparisons 733, 723, is also true. In some instances, a false value for comparisons at points P1 an P2, but not P3, may indicate a “poorer fire” indication. In some instances, more than three comparison points P1, P2, P3 and more than three detection windows 620, 630, 640 are provided. In some instances, each unique combination of true/false results at the comparison points generates a different combustion quality indication. Accordingly, though not specifically shown, in all three comparisons 723, 733, 743 return false, then good fire 390 is indicated.

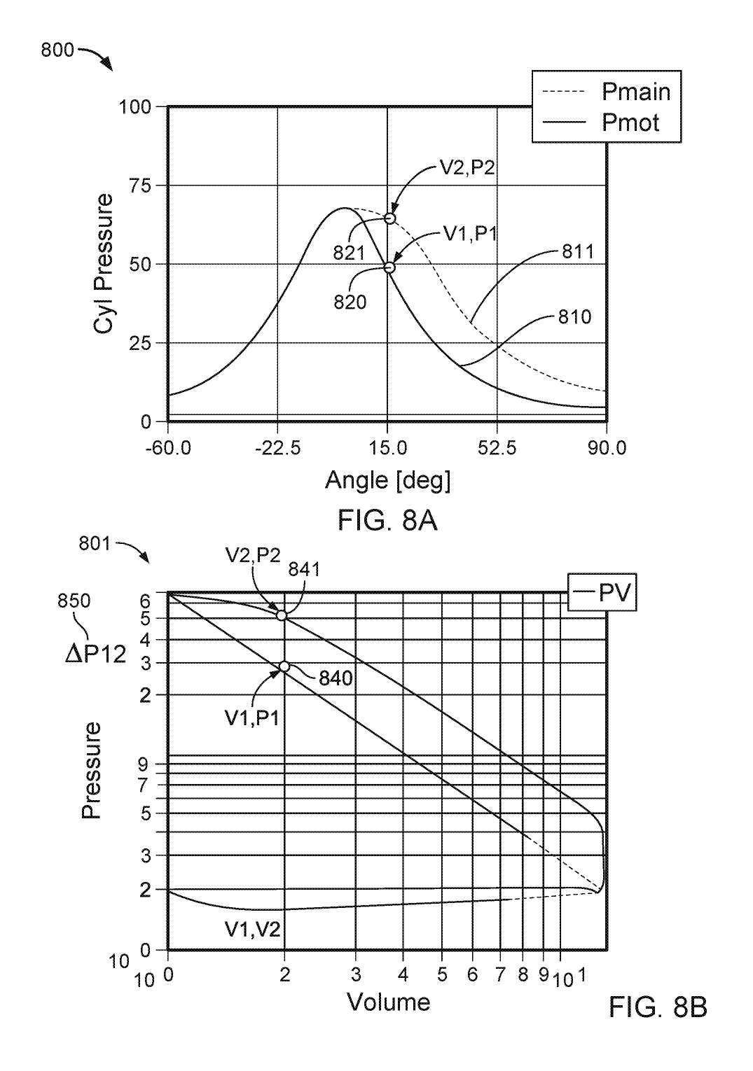

FIG. 8A is a graph 800 showing a curve 811 of a pressure trace vs. crank angle of a combustion event in a cylinder plotted with a curve 810 of the compression of the cylinder before combustion, where FIG. 8B is a pressure vs. volume (PV) graph 801 for the same combustion event of FIG. 8A. In FIG. 8A, a first point 820 is the pressure at a specific volume on the compression curve 811. A second point 821 is the pressure at a specific volume on the expansion curve 810. In FIG. 8A, the compression curve 810 is duplicated on the expansion side of the CA range (i.e., the x-axis). In FIG. 8B, the first point (820 of FIG. 8A) is shown on the PV graph 801 as point 840, and the second point (821 of FIG. 8A) is shown on the PV graph 801 as point 841. Also shown, is a difference 850 (i.e., ΔP) between the two points 840, 841 at their equal volume. Together FIGS. 8A and 8B illustrate a pressure trace resulting from following combustion: CA50=20 ATDC with a burn duration of 25 degrees. As shown, a peak pressure evaluation method would fail because it would not be able to ignore the motored pressure peak which is before and higher than the combustion induced pressure rise at the second point 821.

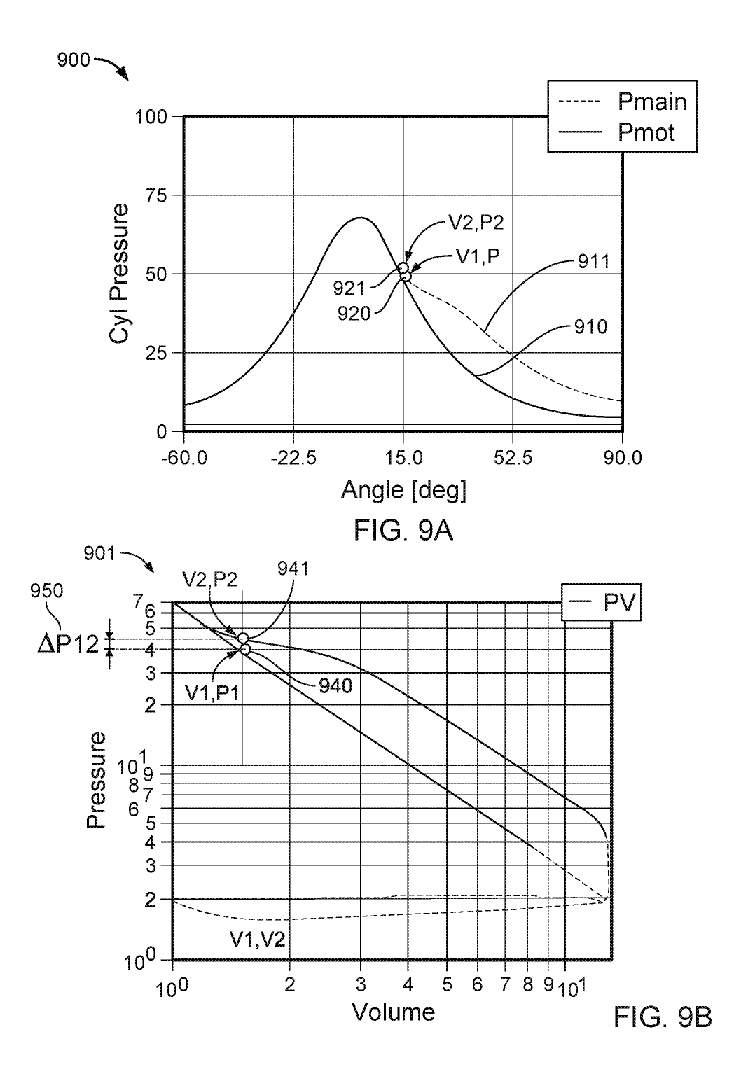

FIG. 9A is a graph 900 showing a curve 911 of a pressure trace vs. crank angle of a combustion event in a cylinder plotted with a curve 910 of the compression of the cylinder before combustion, where FIG. 9B is a pressure vs. volume (PV) graph 901 for the same combustion event of FIG. 9A. In FIG. 9A, a first point 920 is the pressure at a specific volume on the compression curve 911. A second point 921 is the pressure at a specific volume on the expansion curve 910. In FIG. 9A, the compression curve 910 is duplicated on the expansion side of the CA range (i.e., the x-axis). In FIG. 9B, the first point (920 of FIG. 9A) is shown on the PV graph 901 as point 940, and the second point (921 of FIG. 9A) is shown on the PV graph 901 as point 941. Also shown, is a difference 950 (i.e., ΔP) between the two points 940, 941 at their equal volume. Together FIGS. 9A and 9B illustrate a pressure trace resulting from following combustion: CA50=30 ATDC (e.g., retarded 10 degrees) with a burn duration of 25 degrees. As shown, the difference 950 is very small, and, if it was below a threshold value, then a poor fire or misfire indication would be returned by the above-described method.

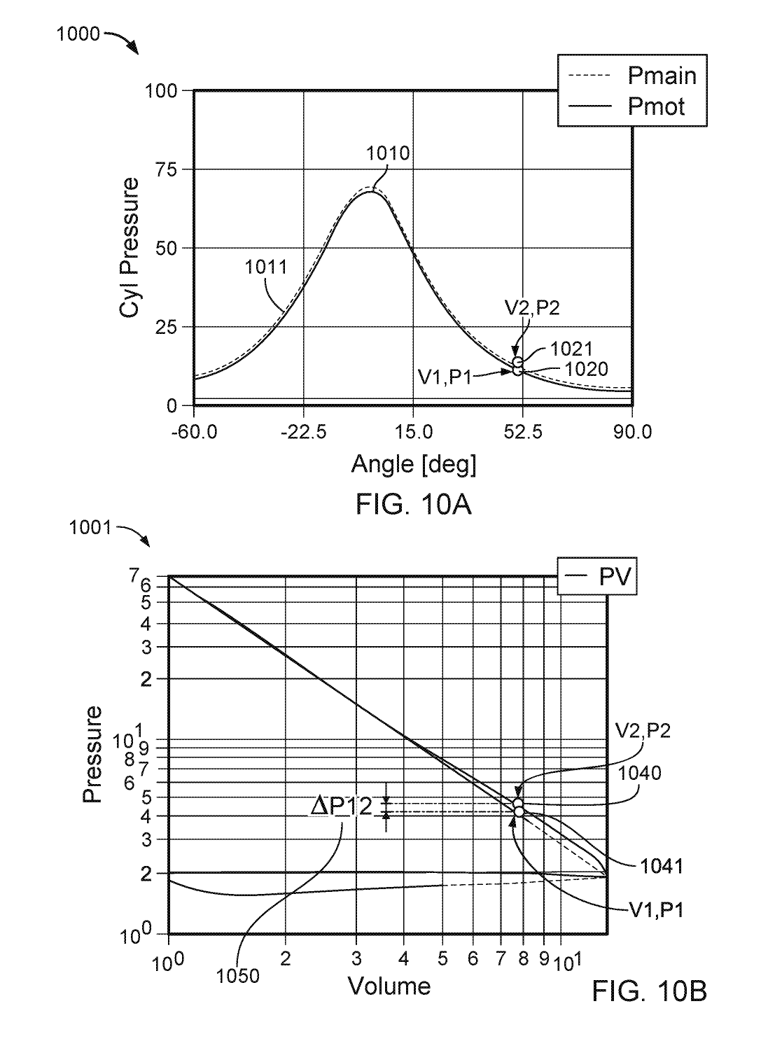

FIG. 10A is a graph 1000 showing a curve 1011 of a pressure trace vs. crank angle of a combustion event in a cylinder plotted with a curve 1010 of the compression of the cylinder before combustion, where FIG. 9B is a pressure vs. volume (PV) graph 1001 for the same combustion event of FIG. 10A. In FIG. 10A, a first point 1020 is the pressure at a specific volume on the compression curve 1011. A second point 1021 is the pressure at a specific volume on the expansion curve 1010. In FIG. 10A, the compression curve 1010 is duplicated on the expansion side of the CA range (i.e., the x-axis). In FIG. 10B, the first point (1020 of FIG. 9A) is shown on the PV graph 1001 as point 1040, and the second point (1021 of FIG. 9A) is shown on the PV graph 1001 as point 1041. Also shown, is a difference 1050 (i.e., ΔP) between the two points 1040, 1041 at their equal volume. Together FIGS. 10A and 10B illustrate a pressure trace for “true misfire”, where the pressure at the second point 1020 is not sufficiently above the pressure at the first point 1010 at this late point in the cycle, where combustion fails to be detectable above the compression.

An example embodiment is an apparatus for controlling operation of an internal combustion engine including a body sealed in a combustion chamber being moveable to a center position to compress gas in a compression phase and movable from the center position by expanding combustion gasses in an expansion phase. The apparatus includes a processor to receive input from a position sensor configured to indicate a position of the body sealed in the combustion chamber and a combustion chamber pressure sensor. The processor is configured to (i) receive a position signal from a position sensor configured to indicate a position of the body sealed in the combustion chamber, (ii) receive a pressure signal from the combustion chamber pressure sensor during a first range of positions, the first range corresponding to a portion of the compression phase, the received pressure being a first pressure, (iii) receive the pressure signal during a second range of positions, the second range corresponding to a portion of expansion phase where the body is equidistant from the center position with the first range or where the volume is equal or equivalent to the first volume, the received pressure being a second pressure, and (iv) determine an indication of combustion quality of a combustion event in the combustion chamber based on a comparison of the difference of the first and second pressures to a threshold value.

In some instances, the first and second position ranges correspond to combustion chamber volumes that are symmetric about a minimum volume of the combustion chamber.

In some instances, the indication of combustion quality includes acceptable combustion and unacceptable combustion.

In some instances, the unacceptable combustion indication of combustion quality further includes a poor-fire indication and a misfire indication.

In some instances, the ECU is further configured to determine a separate indication of combustion quality for combustion cycle during a plurality of combustion cycles, and calculate a combustion quality metric based on the frequency of determined poor-fire and misfire events.

In some instances, the ECU is further configured to determine the poor-fire indication if the difference of the second and first pressures not increase above a poor-fire pressure threshold value, and to determine the misfire indication if the difference of the second and first pressures does not increase above a misfire pressure threshold value.

In some instances, the second range of volumes defines a first sampling location and the processor is configured to sample the pressure signal from the combustion chamber pressure sensor at three or more sampling locations during the expansion phase for misfire detection. Where each of the three or more sampling location is progressively larger in volume then the preceding one, and where the process is configured to indicate “true misfire” if the received pressure at none of the subsequently sampled locations is not above the pressure sampled at the first sampling location plus the threshold value.

In some instances, the ECU is further configured to, trigger an alarm state upon the determining of unacceptable combustion, and upon the triggering of the alarm state, do one or more of the following: (i) advance an ignition timing of future ignition cycles, (ii) reduce a load on the engine, (iii) increase or reduce fuel flow to the engine including stopping duel flow to the engine, and (iv) stop firing of an ignition device in the combustion chamber.

In some instances, the ECU is further configured to trigger an alarm state upon the determining of unacceptable combustion, and upon the triggering of the alarm state, send an alarm signal to a monitoring unit remote from the engine.

In some instances, the ECU is further configured to determine the indication of combustion quality based on a comparison of the difference of the second and first pressures to a poor-fire threshold pressure value and a misfire threshold value.

In some instances, the first and second position ranges define a first detection window, and wherein the ECU is further configured to sample pressure during a second detection window, determine an indication of combustion quality in the first detection window, and determine an indication of combustion quality in the second detection window.

In some instances, ECU is further configured to sample pressure during a third detection window, and determine an indication of combustion quality during the third detection window.

In some instances, the position sensor is a crank angle sensor, the position signal is a crank angle signal, and the first position range is a first crank angle range, and the second position range is a second crank angle range. In some instances, the first and second crank angle ranges are equal in crank angle degrees and are symmetric about a top-dead-center position.

In some instances, the first and second crank angles defines a first detection window, where the ECU is further configured to sample pressure during a second detection window. In some instances, the unacceptable combustion indication of combustion quality includes poor-fire and misfire indication, and the first detection window is a poor-fire detection window includes 60° before and after top-dead-center (TDC), and the second detection window is a misfire detection window and includes 90° before and after TDC.

In some instances, the ECU is further configured to smooth the received first and second pressure signals and average the received first and second pressure signals during the corresponding first and second position ranges using a vector central average method.

Another example is a method in connection with an internal combustion engine including comparing, to a specified threshold, a difference of a compression phase pressure measured in a combustion chamber of the engine during a compression phase in a cycle of the engine to a combustion phase pressure measured in the combustion chamber during a combustion phase of the cycle of the engine, determining whether a misfire event has occurred in the combustion chamber based on the comparing.

In some instances, the internal combustion engine includes a body sealed in the combustion chamber that is moveable to compress gas in the compression phase to a center position and is movable from the center position by expanding combustion gasses in the expansion phase, and where the first pressure and the second pressure are measured with the body equidistant from the center position.

In some instances, the body includes a piston in the combustion chamber, and the piston is reciprocable between a top dead center corresponding to the center position and a bottom dead center, opposite the top dead center.

In some instances, the comparing includes a first comparison and the method includes, in a second comparison, comparing, to a second specified threshold, a difference in a second combustion phase pressure measured in the combustion chamber during the compression phase of the cycle of the engine to a second combustion phase pressure measured in the combustion chamber during the combustion phase of the cycle of the engine, where the third pressure and the fourth pressure were measured with the body equidistant from the center position. And where determining whether a misfire has occurred in the combustion chamber includes determining whether a misfire has occurred in the combustion chamber based on the first comparison and the second comparison.

In some instances, the first and second pressures are measured during equal and opposite ranges of body positions in the combustion chamber, and where the first and second pressures are averaged using a vector central average method prior to the comparison of their difference to the specified threshold.

In some instances, the method further includes calculating the frequency of a misfire event or a poor-fire event, and based on the frequency, doing one or more of the following: (i) advancing the ignition timing of the internal combustion engine, and reducing a load on internal combustion engine, (ii) re-calculating the frequency after advancing the timing or reducing the load, and (iii) based on the recalculating, doing one or more of the following: (a) trigger an alarm state, (b) adjusting the fuel flow to the engine, and (c) stopping firing of an ignition device in the combustion chamber.

Generally, the devices and methods described herein, in some configurations, detect poor fire and misfire events in a single engine cylinder during a single combustion event. In some embodiments this detection is achieved by directly measuring in-cylinder pressure across one or more equal and opposite crank angle ranges to inspect the pressure rise in each cylinder during each combustion event at crank angles indicative of locations where good fire, misfire, and poor fire are expected to present detectable pressure comparisons before and after combustion.

### ACRONYMS/ABBREVIATIONS

ATDC=after top dead center
BTDC=before top dead center
CA50=location of 50% mass fraction burn (crank angle degrees ATDC)
CAN=controller area network
COV=coefficient of variation
ECU=engine control unit
EGR=exhaust gas recirculation
HCCI=homogeneous charge compression ignition
IMEP=indicated mean effective pressure (bar)
IVC=intake valve closing angle
LTC=low temperature combustion
MAP=manifold absolute pressure (bar)
MAT=manifold absolute temperature (K)
NOx=oxides of nitrogen
PCCI=premixed charge compression ignition
Ploc=location of peak pressure (crank angle degrees ATDC)
Pₘₐₓ=maximum cylinder pressure (bar)
R&D=research and development
RCCI=reactivity controlled compression ignition
RPR=rate of pressure rise (bar/crank angle degree)
RT-CDC=real-time combustion diagnostics and control
SOC=start of combustion (crank angle degrees ATDC)

A number of embodiments have been described. Nevertheless, it will be understood that various modifications may be made. Accordingly, other embodiments are within the scope of the following claims.

1. An apparatus for monitoring and/or controlling operation of an internal combustion engine, the engine comprising a body sealed in a combustion chamber, the body being moveable to a center position to compress gas in a compression phase and movable from the center position by expanding combustion gasses in an expansion phase, and the apparatus comprising:
a processor to receive input from a position sensor configured to sense a position of the body and from a combustion chamber pressure sensor, the processor configured to:
receive a pressure signal from the combustion chamber pressure sensor during a first range of volumes, the first range corresponding to a portion of the compression phase, the received pressure being a first pressure;
receive the pressure signal during a second range of volumes, the second range corresponding to a portion of the expansion phase where the thermodynamic volume is equal to the first range of volumes, the received pressure being a second pressure;
determine an indication of combustion quality of a combustion event in the combustion chamber based on a comparison of the difference between of the first and second pressures to a threshold value; and
adjust an operational parameter of the internal combustion engine based on the indication of combustion quality.

2. The apparatus of claim 1, where the first and second volume ranges correspond to combustion chamber volumes that are symmetric about a minimum volume of the combustion chamber.

3. The apparatus of claim 1, where the indication of combustion quality includes good fire and misfire, where the threshold comprises a misfire threshold, where the processor is configured to:
determine good fire if the difference is above the misfire threshold; and
indicate misfire if the difference is below the misfire threshold.

4. The apparatus of claim 3, where the indication of combustion quality further includes poor-fire, where the threshold comprises a poor-fire threshold that is larger than the misfire threshold, and where the processor is configured to:
determine good fire if the difference is above the poor-fire threshold;
determine poor-fire if the different is between the poor-fire threshold and the misfire threshold; and
determine misfire if the difference is and where the misfire threshold is larger than the poor-fire threshold.

5. The apparatus of claim 4, where the processor is further configured to:
determine a separate indication of combustion quality for each combustion event during a plurality of combustion events; and
calculate a combustion quality metric based on the frequency of determined poor-fire and misfire indications.

6. The apparatus of claim 3, wherein the first and second ranges of volumes define a first sampling window,
wherein the processor is configured to receive the pressure signal from the combustion chamber pressure sensor at three or more sampling windows for misfire detection,
wherein each of the three or more sampling windows comprises a compression range of volumes during different portions of the compression phase and an expansion range of volumes during a corresponding portion of expansion phase where the thermodynamic volume is equal to the compression range of volumes, wherein the expansion volumes of the three or more sampling windows is progressively larger in volume then the preceding one,
wherein the processor is configured to compare, for each of the three or more sampling windows, the difference between the received expansion pressure and the received expansion pressure to a corresponding misfire threshold, and
wherein the processor is configured to determine “true misfire” if the differences of none of the three or more sampling windows is larger than the corresponding misfire threshold.

7. The apparatus of claim 3, where the processor is further configured to:
trigger an alarm state upon the determining of poor fire or misfire; and
upon the triggering of the alarm state, do one or more of the following adjustments of an operational parameter of the internal combustion engine:
advance an ignition timing of future ignition events,
reduce a load on the engine,
increase or reduce fuel flow to the engine, including stopping fuel flow to the engine, and
stop firing of an ignition device in the combustion chamber.

8. The apparatus of claim 3, where the processor is further configured to:
trigger an alarm state upon the determining of poor fire or misfire, and
upon the triggering of the alarm state, send an alarm signal to a monitoring unit remote from the engine.

9. (canceled)

10. The apparatus of claim 1, where the first and second volume ranges define a first detection window, and wherein the processor is further configured to:
sample pressure during a second detection window,
determine an indication of combustion quality in the first detection window, and
determine an indication of combustion quality in the second detection window.

11. The apparatus of claim 10, where the processor is further configured to:
sample pressure during a third detection window,
and determine an indication of combustion quality during the third detection window.

12. The apparatus of claim 1, where the position sensor is a crank angle sensor, and wherein the position signal is a crank angle signal, and wherein the first volume range is a first crank angle range, and wherein the second volume range is a second crank angle range.

13. The apparatus of claim 12, where the first and second crank angles defines a first detection window, wherein the processor is further configured to sample pressure during a second detection window, and
wherein the first detection window is a poor-fire detection window that includes 60° before and after top-dead-center (TDC), and wherein the second detection window is a misfire detection window that includes 90° before and after TDC.

14. The apparatus of claim 1, wherein the processor is further configured to, for each of the pressure signals received during the first and second volume ranges, smooth and average the pressure signals during the corresponding first and second volume ranges using a vector central average method.

15. A method performed in connection with an internal combustion engine, the method comprising:
comparing, to a specified threshold, a difference between a first pressure measured in a combustion chamber of the engine during a compression phase of a combustion event in a cycle of the engine and a second pressure measured in the combustion chamber during an expansion phase of the combustion event of the engine, where the first pressure and the second pressure were measured at equal thermodynamic volumes of the combustion event in the combustion chamber;
determining whether a misfire event has occurred in the combustion chamber based on the comparing, where the misfire event is determined to occur when the difference is less than the misfire threshold; and
adjusting an operational parameter of the internal combustion engine based on the determining of the misfire event.

16. The method of claim 15, where the internal combustion engine comprises a body sealed in the combustion chamber that is moveable to compress gas in the compression phase to a center position and is movable from the center position by expanding combustion gasses in the expansion phase.

17. The method of claim 16, where the body comprises a piston in the combustion chamber, the piston reciprocable between a top dead center corresponding to the center position and a bottom dead center, opposite the top dead center.

18. The method of claim 16, where the comparing comprises a first comparison and where the method comprises:
in a second comparison, comparing, to a second specified threshold, a difference between a third pressure measured in the combustion chamber during the compression phase of the engine and a fourth pressure measured in the combustion chamber during the combustion phase of the engine, where the third pressure and the fourth pressure were measured at equal thermodynamic volumes; and
where determining whether a misfire has occurred in the combustion chamber comprises determining whether a misfire has occurred in the combustion chamber based on the first comparison and the second comparison.

19. The method of claim 15, where the first and second pressures are each averaged using a vector central average method prior to the comparison of their difference to the specified threshold.

20. The method of claim 15, further including:
calculating the frequency of the misfire event;
based on the frequency, doing one or more of the following:
advancing the ignition timing of the internal combustion engine, and
reducing a load on internal combustion engine; and
re-calculating the frequency after advancing the timing or reducing the load, and based on the recalculating, doing one or more of the following:
trigger triggering an alarm state,
adjusting fuel flow to the engine, and
stopping firing of an ignition device in the combustion chamber.

21. The apparatus of claim 1, where each position of the body defines a volume of the combustion chamber, where the position sensor is configured to sense a position of the body corresponding to the volume of the combustion chamber, where the processor is configured to calculate a thermodynamic volume of the combustion event in the combustion chamber based at least partially on the sensed position, and where first and second ranges of volumes comprise first and second ranges of equal thermodynamic volumes of the combustion event.

22. The method of claim 16, comprising sensing a position of the body corresponding to the volume of the combustion chamber and calculating a thermodynamic volume of the combustion event in the combustion chamber based at least partially on the sensed position, and where first and second pressures are measured at equal thermodynamic volumes of the combustion event.
